(19) United States
(12) Patent Application Publication
(10) Pub. No.: US 2022/0166233 A1
(43) Pub. Date: May 26, 2022

(54) ELECTRIC VEHICLE CHARGING DEPOT AND PROTECTION CONTROL MODULE THEREFOR

(71) Applicant: eCamion Inc., Toronto (CA)

(72) Inventors: Carmine N. Pizzurro, Toronto (CA); Himanshu Sudan, Toronto (CA); Richard W. Szymczyk, Toronto (CA); Youhan Fu, Toronto (CA); Reza Iravani, Toronto (CA)

(21) Appl. No.: 17/465,289

(22) Filed: Sep. 2, 2021

Related U.S. Application Data
(60) Provisional application No. 63/117,991, filed on Nov. 24, 2020.

(51) Int. Cl. H02J 7/00; H02J 7/35; H02J 3/38; B60L 53/62; B60L 53/67; B60L 58/12; B60L 53/51; B60L 53/52; B60L 53/20

(52) U.S. Cl. CPC H02J 7/0031; B60L 2210/40; H02J 7/0034; H02J 7/35; H02J 3/381; B60L 53/62; B60L 53/67; B60L 58/12; B60L 53/51; B60L 53/52; B60L 53/20; H02J 2300/28; H02J 2300/22; B60L 2210/10; B60L 2210/30; H02J 7/0048

(57) ABSTRACT

An electric vehicle charging depot comprises a direct current (DC) bus configured to receive DC power from one or more power sources, the one or more power sources at least including a public transit light rail and/or subway power source; at least one electric vehicle charging stall connected to the DC bus and configured to charge an electric vehicle load; and at least one control module configured to monitor and control power flow from the DC bus to the at least one electric vehicle charging stall.

### CROSS-REFERENCE TO RELATED APPLICATION

This application claims the benefit of U.S. Provisional Application No. 63/117,991 filed on Nov. 24, 2020, the entire content of which is incorporated herein by reference.

### FIELD

The subject disclosure relates to an electric vehicle charging depot and to a protection control module therefor.

### BACKGROUND

Climate change has become an increasingly more popular topic and with it, a push has been made on many fronts to reduce reliance on fossil fuels and move to sources of cleaner “green” energy. Not surprisingly, in view of this push the introduction of electric vehicles has been embraced by both individual consumers and industry.

Since 2018, transportation electrification has become more and more a point of attention for public transit systems in both developed and developing countries. This is especially true in countries acknowledging climate change and reinforcing requirements on emission reduction and advancements of electric vehicle technologies. In such countries, the electric bus has become one of the most popular vehicles, due to its low requirement on public transit infrastructure change and high similarity to the conventional busses that run on fossil fuels. In addition to running on cleaner power, electric busses have the benefit that they may help to reduce operating costs through, for example, automated charging instead of manual refueling, and improve resource efficiency by allowing existing public transit infrastructure to be used for grid servicing.

Although the introduction of electric busses to public transit systems continues and advantages are expected, challenges are also expected. The mass introduction of high power electric bus supply equipment (EBSE) at approximately 350 W to 500 kW, may affect the performance of existing power distribution infrastructure, and the ability to integrate existing public transit infrastructure or renewable power sources into electric bus charging networks.

Furthermore in public transit systems with mass deployment of electric busses, the connectivity, control and coordination within and between electric bus charging depots, where available charging stalls or slots and available charging power must be constantly monitored to allow charging sessions to be scheduled, presents challenges. As will be appreciated, in environments of this nature, improvements are desired.

It is therefore an object to provide a novel electric vehicle charging depot and to a novel protection control module therefor.

This background serves only to set a scene to allow a person skilled in the art to better appreciate the following detailed description. None of the above discussion should necessarily be taken as an acknowledgment that this discussion is part of the state of the art or is common general knowledge.

### BRIEF DESCRIPTION

It should be appreciated that this brief description is provided to introduce a selection of concepts in a simplified form that are further described below in the detailed description. This brief description is not intended to be used to limit the scope of claimed subject matter.

Accordingly, in one aspect there is provided an electric vehicle charging depot comprising: a direct current (DC) bus configured to receive DC power from one or more power sources, the one or more power sources at least including a light rail and/or subway power source; at least one electric vehicle charging stall connected to the DC bus and configured to charge an electric vehicle load; and at least one control module configured to monitor and control power flow from the DC bus to the at least one electric vehicle charging stall.

In one or more embodiments, the electric vehicle charging depot comprises a plurality of electric vehicle charging stalls, and the at least one control module is configured to monitor and control power flow from the DC bus to each electric vehicle charging stall.

In one or more embodiments, the one or more power sources further comprises an energy storage system. In one form, the at least one control module is configured to monitor and control power flow from the energy storage system to the DC bus and/or power flow from the DC bus to the energy storage system. In one form, the at least one control module is configured to monitor the state of charge of the energy storage system and to control power flow from the energy storage system and power flow to the energy storage system based on the state of charge of the energy storage system. In one form, the at least one control module is configured to enable power flow from the energy storage system to the DC bus when the DC power on the DC bus is insufficient to meet electric vehicle charging loads and the state of charge of the energy storage system is above a lower charge limit, and is configured to enable power flow from the DC bus to the energy storage system when the DC power on the DC bus exceeds electric vehicle charging loads and the state of charge of the energy storage system is below an upper charge limit. In one form, the at least one control module is configured to monitor the charge and discharge rates of the energy storage system.

In one or more embodiments, the one or more power sources further comprises at least one renewable energy source. In one form, the at least one renewable energy source comprises at least one solar power and/or wind power source. In one form, the at least one control module is configured to monitor and control power flow from the at least one renewable energy source to the DC bus. In one form, the at least one control module is configured to communicate with at least one DC to DC converter connecting the at least one renewable energy source to the DC bus.

In one or more embodiments, the at least one control module is configured to isolate the at least one electric vehicle charging station from the DC bus in the event of an unsafe operating condition. In one form, the at least one control module is configured to isolate the at least one electric vehicle charging stall from the DC bus in the event of one or more of (i) current flow in an improper direction, (ii) an out of tolerance current condition, (iii) an out of tolerance voltage condition, and (iv) a ground fault condition.

In one or more embodiments, the electric vehicle charging depot comprises a plurality of electric vehicle charging stalls, at least one of the electric vehicle charging stalls being configured to engage an electric bus pantograph. In one form, each electric vehicle charging station comprises a DC to DC converter module and an electric vehicle charging interface. In one form, each electric vehicle charging stall is connected to the DC bus via protection control, and wherein the protection control is responsive to the at least one control module to isolate the electric vehicle charging stall from the DC bus in the event of an unsafe operating condition. In one form, the protection control is configured to isolate the electric vehicle charging stall from the DC bus in the event of one or more of (i) current flow in an improper direction, (ii) an out of tolerance current condition, (iii) an out of tolerance voltage condition, and (iv) a ground fault condition.

According to another aspect there is provided a protection control module for interconnection between at least one electric vehicle charging stall and a direct current (DC) power bus, comprising: a current monitor configured to measure current flow from the DC power bus to the electric vehicle charging stall; at least one voltage monitor configured to measure voltage on the DC power bus; a power flow monitor configured to measure power flow direction between the DC power bus and the electric vehicle charging stall; and protection control circuitry configured to isolate the DC power bus and the electric vehicle charging stall in the event of an unsafe electric vehicle charging operation.

In one or more embodiments, the protection control circuitry is conditioned to isolate the DC power bus and the electric vehicle charging stall in the event of one or more of (i) current flow in an improper direction, (ii) an out of tolerance current condition, (iii) an out of tolerance voltage condition, and (iv) a ground fault condition.

In one or more embodiments, the protection control module further comprises a power conditioning module configured to filter and stabilize voltage.

### BRIEF DESCRIPTION OF THE DRAWINGS

Embodiments will now be described more fully with reference to the accompany drawings in which:

FIG. 1 is a schematic diagram of a multi-input, multi-output (MIMO) electric vehicle charging depot;

FIG. 2 is a schematic diagram of a power connection module forming part of the MIMO electric vehicle charging depot of FIG. 1; and

FIG. 3 is a schematic diagram of an alternative MIMO electric vehicle charging depot.

### DETAILED DESCRIPTION

The foregoing brief description, as well as the following detailed description of certain examples will be better understood when read in conjunction with the accompanying drawings. As used herein, a feature, structure, element, component etc. introduced in the singular and preceded by the word “a” or “an” should be understood as not necessarily excluding the plural of the features, structures, elements, components etc. Further, references to “one example” or “one embodiment” are not intended to be interpreted as excluding the existence of additional examples or embodiments that also incorporate the described features, structures, elements, components etc.

Unless explicitly stated to the contrary, examples or embodiments “comprising” or “having” or “including” a feature, structure, element, component etc. or a plurality of features, structures, elements, components etc. having a particular property may include additional features, structures, elements, components etc. not having that property. Also, it will be appreciated that the terms “comprises”, “has”, “includes” means “including but not limited to” and the terms “comprising”, “having” and “including” have equivalent meanings.

As used herein, the term “and/or” can include any and all combinations of one or more of the associated listed features, structures, elements, components or other subject matter.

It will be understood that when a feature, structure, element, component etc. is referred to as being “on”, “attached” to, “affixed” to, “connected” to, “coupled” with, “contacting”, etc. another feature, structure, element, component etc. that feature, structure, element, component etc. can be directly on, attached to, connected to, coupled with or contacting the feature, structure, element, component etc. or intervening features, structures, elements, components etc. may also be present. In contrast, when a feature, structure, element, component etc. is referred to as being, for example, “directly on”, “directly attached” to, “directly affixed” to, “directly connected” to, “directly coupled” with or “directly contacting” another feature, structure, element, component etc. there are no intervening features, structures, elements, components etc. present.

It will be understood that spatially relative terms, such as “under”, “below”, “lower”, “over”, “above”, “upper”, “front”, “back” and the like, may be used herein for ease of description to describe the relationship of a feature, structure, element, component etc. to another feature, structure, element, component etc. as illustrated in the figures. The spatially relative terms can however, encompass different orientations in use or operation in addition to the orientation depicted in the figures.

Reference herein to “example” means that one or more feature, structure, element, component, characteristic and/or operational step described in connection with the example is included in at least one embodiment and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Reference herein to “configured” denotes an actual state of configuration that fundamentally ties the feature, structure, element, component, or other subject matter to the physical characteristics of the feature, structure, element, component or other subject matter preceding the phrase “configured to”. Thus, “configured” means that the feature, structure, element, component or other subject matter is designed and/or intended to perform a given function. Thus, the use of the term “configured” should not be construed to mean that a given feature, structure, element, component, or other subject matter is simply “capable of” performing a given function but that the feature, structure, element, component, and/or other subject matter is specifically selected, created, implemented, utilized, and/or designed for the purpose of performing the function. Subject matter that is described as being configured to perform a particular function may additionally or alternatively be described as being operative to perform that function.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of a lower-numbered item (e.g., a “first” item) and/or a higher-numbered item (e.g., a “third” item).

As used herein, the terms “approximately”, “about”, “substantially”, “generally” etc. represent an amount or condition close to the stated amount or condition that results in the desired function being performed or the desired result being achieved. For example, the terms “approximately”, “about”, “substantially”, “generally” etc. may refer to an amount or condition that is within engineering tolerances to the precise value or condition specified that would be readily appreciated by a person skilled in the art.

In general, an electric vehicle charging depot, center, station etc. (hereinafter referred to as “depot”) is described that comprises a direct current (DC) bus configured to receive DC power from one or more power sources. The one or more power sources at least includes a light rail and/or subway power source. At least one electric vehicle charging stall is connected to the DC bus and is configured to charge an electric vehicle load. At least one control module is configured to monitor and control power flow from the DC bus to the at least one electric vehicle charging stall. Further specifics concerning exemplary electric vehicle charging depots will now be described.

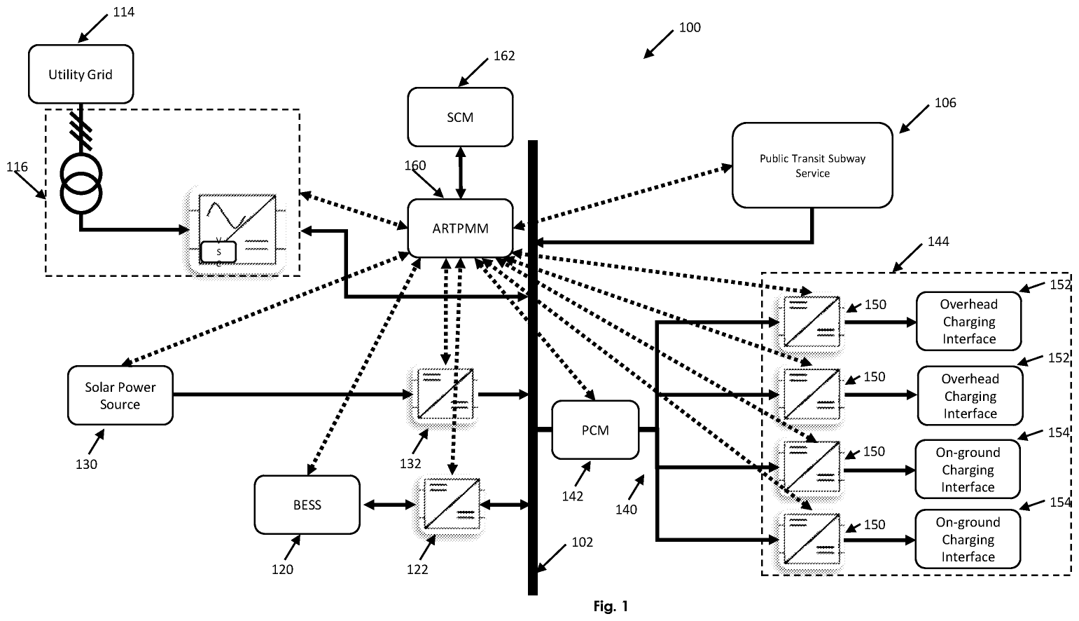

Turning now to FIG. 1, a multi-input, multi-output (MIMO) electric vehicle charging depot is shown and is generally identified by reference numeral 100. In this embodiment, the MIMO electric vehicle charging depot 100 is particularly suited for use in conjunction with a public transit system and makes use of the public transit system DC power supply as its main source of power. Those of skill in the art will however appreciate that the MIMO electric vehicle charging depot 100 may be used in other environments.

As can be seen, the MIMO electric vehicle charging depot 100 comprises a common direct current (DC) bus 102 that receives power from one or more sources of power and that provides power to electric vehicle charging equipment in electric vehicle charging stalls of one or more electric vehicle charging bays to allow electric vehicles to be charged quickly as will be described.

In the embodiment shown, the common DC bus 102 is connected to four (4) separate sources of power. Those of skill in the art will appreciate however that the common DC bus 102 may receive power from more or fewer sources of power. In this example, the common DC bus 102 is an extension of the DC power supply used to power above ground light rail services, streetcars or trolley services and/or subway or underground rail services of a public transit system. In the case of light rail and subway services, the common DC bus 102 is an extension of the existing “third rail” of these services.

As shown in FIG. 1, the common DC bus 102 is an extension of the existing third rail of a public transit subway service 106. The third rail of the public transit subway service 106 is the primary source of DC power to the common DC bus 102 with the other sources of power being used to supply power to the common DC bus 102 during third rail off-line conditions or in the event of insufficient power levels on the common DC bus 102 as will be described. Although not shown, those of skill in the art will appreciate that switchgear or equivalent device(s) for circuit isolation/disconnection, other protection devices (fuses, breakers etc.) and an electromagnetic interference (EMI) filter are provided between the third rail of the public transit subway system 106 and the common DC bus 102.

In this example, the common DC bus 102 is also connected to a three-phase alternating current (AC) utility grid 114 via a feeder station 116. The feeder station 116 comprises, for example, circuit breakers and contactors, a static VAR compensator, a transformer, and a three-phase, bi-directional voltage source converter (VSC). As is known to those of skill in the art, the circuit breakers open automatically during unsafe conditions to electrically isolate the feeder station 116 from the utility grid 114. The contactors can be controlled manually or automatically to isolate the feeder station 116 from the utility grid 114. The static VAR compensator is configured to filter harmonics, regulate the output voltage, and control the power factor to keep the power factor close to unity. During power delivery from the utility grid 114 to the common DC bus 102, the transformer steps down the AC voltage received from the utility grid 114 to the required voltage (e.g. 600V) and the bi-directional VSC converts the AC power to DC power for supply to the common DC bus 102. During power delivery from the common DC bus 102 to the utility grid 114, the bi-directional VSC converts DC power on the common DC bus 102 to AC power and the transformer steps up the AC voltage to the required voltage for supply to the utility grid 114 or to designated loads at a host facility (not shown).

The common DC bus 102 is connected to an energy storage system 120 via a bi-directional DC to DC converter 122. In this example, the energy storage system 120 is a battery energy storage system (BESS). BESS 120 comprises a bank of rechargeable energy storage devices in the form of rechargeable batteries and is configured to deliver DC power to the common DC bus 102 via the bi-directional DC to DC converter 122 when insufficient DC power levels on the common DC bus 102 are detected thereby to stabilize power on the common DC bus 102. BESS 120 is also configured to draw DC power from the common DC bus 102 via the bi-directional DC to DC converter 122 when excess DC power is on the common DC bus 102 allowing the BESS 120 to charge.

Depending on the geographical location of the MIMO electric vehicle charging depot 100, the common DC bus 102 may also be connected to one or more other sources of power such as renewable power sources e.g. solar power farms, wind power farms etc. For example as shown in FIG. 1, the common DC bus 102 is connected to and receives power from a solar power source 130 comprising one or more solar panel arrays via a DC to DC converter 132. The DC to DC converter 132 is configured to ensure the DC output of the solar power source 130 is at the required voltage for supply to the common DC bus 102.

The common DC bus 102 is also connected to one or more electric vehicle charging bays 140, one electric vehicle charging bay of which is shown for illustrative purposes only, via a power connection module (PCM) 142. The electric vehicle charging bay 140 comprises a plurality of electric vehicle charging stalls 144 configured to facilitate both the charging of electric cars and/or trucks and the charging of electric busses. In the example shown, the electric vehicle charging bay 140 comprises four (4) electric vehicle charging stalls 144. Two of the electric vehicle charging stalls 144 are particularly suited to facilitate charging of electric busses and two of the electric vehicle charging stalls 144 are particularly suited to facilitate charging of electric cars and/or trucks. In the case of the electric vehicle charging stalls 144 configured to facilitate charging of the electric busses, each electric vehicle charging stall 144 comprises a DC to DC converter module 150 and an overhead charging interface 152 configured to engage with the pantograph on the top of an electric bus. In the case of the electric vehicle charging stalls 144 configured to facilitate charging of electric cars and/or trucks, each electric vehicle charging stall 144 comprises a DC to DC converter module 150 and an on-ground charging interface 154 having a power cable and connector (not shown) to engage with an electric car or truck.

Each DC to DC converter module 150 comprises a DC to AC converter, an intermediate high frequency step down transformer, and an AC to DC converter that are connected in series. Each DC to DC converter module 150 is connected between the PCM 142 its associated charging interface 152, 154 and is configured to provide up to about 125 kW within a voltage range of about 200V to about 500V to electric vehicle loads via the associated charging interface 152, 154.

Although the electric vehicle charging bay 140 is shown as having four electric vehicle charging stalls 144, those of skill in the art will appreciate that this is for ease of illustration only. In a typical MIMO electric vehicle charging depot 100, the electric vehicle charging bay 140 will include more electric vehicle charging stalls 144 with the number and configuration of the electric vehicle charging stalls 144 being selected to allow the fleet of vehicles that use the MIMO electric vehicle charging depot 100 to be properly serviced. Of course if desired, the electric vehicle charging bay 140 may have fewer electric vehicle charging stalls 144.

In this embodiment, the MIMO electric vehicle charging depot 100 employs two levels of management and control that govern the real-time performance of the MIMO electric vehicle charging depot 100 and the scheduling of electric vehicle charging sessions. In particular, the MIMO electric vehicle charging depot 100 comprises an adaptive real-time power management module (ARTPMM) 160 configured to monitor, analyze, and control power flow to and from the common DC bus 102 and a supervisory control module (SCM) 162 configured to manage total energy usage, energy allocation, electric vehicle charging scheduling, grid services and the connectivity/interfacing with external systems.

The ARTPMM 160 in this embodiment is configured to (i) measure external load and power quality on the common DC bus 102, (ii) estimate and control incoming power received from each renewable power source such as the solar power source 130, and (iii) plan and assign a setpoint with respect to power exchange with the utility grid 114. Based on (i), (ii), and (iii), the ARTPMM 160 is configured to (iv) plan and set the maximum power draw limit of each electric vehicle charging stall 144 from the common DC bus 102. Based on (i), (ii), (iii), and (iv), the ARTPMM 160 is configured to (v) plan and adjust power draw from the BESS 120 to the common DC bus 102 via the bi-directional DC to DC converter 122 or power supply to the BESS 120 from the common DC bus 102 via the bi-directional DC to DC converter 122.

The ARTPMM 160 communicates with the public transit subway service 106, the feeder station 116, the bi-directional DC to DC converter 122, the solar power source 130, the DC to DC converter 132, the PCM 142, and the DC to DC converter modules 150 as indicated by the dotted lines shown in FIG. 1. The ARTPMM 160 in this embodiment resides on a programmed computing device such as a host computer, server or other suitable processing device that comprises, for example, one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the one or more processors.

The SCM 162 in this embodiment similarly resides on a programmed computing device such as a host computer, server other suitable processing device that comprises, for example, one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the one or more processors. As will be appreciated, the ARTPMM 160 and SCM 162 may reside on a common programmed computing device or discrete programmed computing devices.

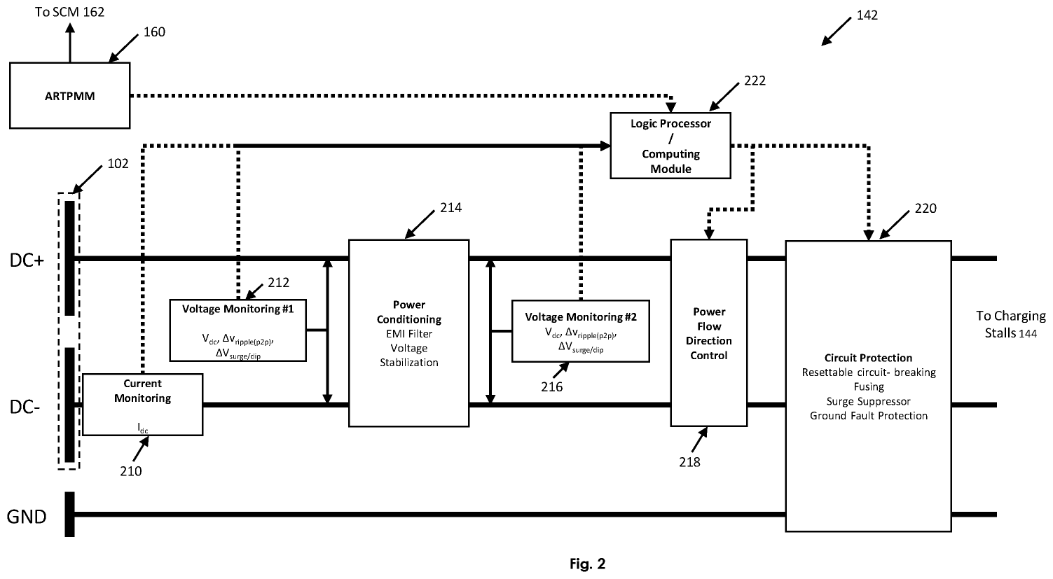

Turning now to FIG. 2, the PCM 142 is better illustrated. As can be seen, the PCM 142 comprises a current monitoring module 210 connected to the negative rail DC− of the common DC bus 102 that is configured to monitor current flow I_{dc} on the common DC bus 102. The current monitoring module 210 comprises one or more current sensors and associated circuitry, firmware, hardware etc. to allow out of tolerance current conditions to be detected. A voltage monitoring module 212 is connected across the positive rail DC+ and negative rail DC− of the common DC bus 102 and comprises one or more voltage sensors and associated circuitry, firmware, hardware etc. The voltage monitoring module 212 is configured to monitor the voltage V_{dc}, the voltage ripple including the peak-to-peak amplitude of the voltage ripple and the ripple frequency, and voltage surges/dips including the amplitudes, durations and frequency of occurrence of the voltage surges/dips appearing on the common DC bus 102 thereby to allow out of tolerance voltage conditions to be detected.

A power conditioning circuit module 214 is also connected across the positive and negative rails DC+ and DC− of the common DC bus 102 downstream of the current and voltage monitoring modules 210 and 212. The power conditioning circuit module 214 in this embodiment comprises an electromagnetic interference (EMI) filter and a voltage stabilizer that are configured to stabilize the voltage, filter harmonics, and smooth ripples of DC power drawn from the common DC bus 102.

A second voltage monitoring module 216 similar to voltage monitoring module 214 is connected across the positive and negative rails DC+ and DC− of the common DC bus 102 downstream of the power conditioning circuit module 214. The second voltage monitoring module 216 is similarly configured to monitor the voltage V_{dc}, the voltage ripple including the peak-to-peak amplitude of the voltage ripple and the ripple frequency, and voltage surges/dips including the amplitudes, durations and frequency of occurrence of the voltage surges/dips of the DC power drawn from the common DC bus 102 after conditioning by the power conditioning circuit module 214.

A power flow direction control module 218 is connected across the positive and negative rails DC+ and DC− of the common DC bus 102 downstream of the second voltage monitoring module 216. The power flow direction control module 218 in this embodiment is configurable to operate in either a uni-directional power mode or a bi-directional power mode.

A circuit protection module 220 is connected across the positive and negative rails DC+ and DC− of the common DC bus 102 downstream of the power flow direction control module 218 and to ground GND. The circuit protection module 220 in this embodiment comprises circuitry including, for example, one or more resettable circuit breakers configured to provide over voltage, over current, and short circuit protection, a surge protector/suppressor configured to protect the DC to DC converter modules 150 from voltage surges/dips and a ground fault interruption (GFI) circuit configured to isolate the electric vehicle charging stalls 144 from the common DC bus 102 in the event of ground faults.

A control module 222 receives current level input from the current monitoring module 210, and voltage, voltage ripple and voltage surge/dip input from the voltage monitoring modules 212 and 216 as well as input from the circuit protection module 220. The control module 222 receives limit settings and a power direction flow setting from the ARTPMM 160 and provides output to the power flow direction control module 218 and the circuit protection module 220 to set the operating mode of the power flow direction control module 218 and to set the trigger thresholds of the circuit protection module 220. The control module 222 provides the current level, voltage, voltage ripple and voltage surge/dip input to the ARTPMM 160 to allow the ARTPMM to determine the power quality on the common DC bus 102. The control module 222 also provides the status of the circuit protection module 220 to the ARTPMM 160.

In operation of the PCM 142, the control module 222 receives the limit settings and power flow direction setting from the ARTPMM 160 and configures the mode of the power flow direction control module 218 in accordance with the power flow direction setting. Once the mode of the power flow direction control module 218 has been configured, the downstream electric vehicle charging stalls 144 are allowed to engage and move power (e.g uni-directionally or bi-directionally). In the uni-directional power mode, the electric vehicle charging stalls 144 are allowed to draw power from the common DC bus 102 via the PCM 142 thereby to allow electric vehicles engaged with the charging interfaces 152, 154 of the electric vehicle charging stalls 144 to be charged. In the bi-directional power mode, again the electric vehicle charging stalls 144 are allowed to draw power from the common DC bus 102 via the PCM 142 thereby to allow electric vehicles engaged with the charging interfaces 152, 154 of the electric vehicle charging stalls 144 to be charged. If necessary however, in the bi-directional power mode using V2G (vehicle to grid) technology, DC power can be drawn from the batteries of electric vehicles engaged with charging interfaces 152, 154 of the electric vehicle charging stalls 144 and supplied to the common DC bus 102 via the PCM 142 and then to the utility grid 114. As a result, the electric vehicle charging depot 100 can act as an aggregator to monitor and control power flow from electric vehicles to the common DC bus 102 and then to the utility grid 114. In this case, the BESS 120 acts as a power buffer to draw power from the common DC bus 102 in the event of excess power on the common DC bus 102 and provided the BESS 120 is below its maximum charge limit.

During power exchange, the control module 222 substantially continuously receives input from the current monitoring, voltage monitoring, and circuit protection modules 210, 212, 216, and 220, respectively, at high frequency and substantially constantly checks to determine if one or more operating conditions that exceed the limit settings arise. The operating conditions comprise for example an operating condition of an electric vehicle charging stall 144 that results in power flow in an improper direction or an out of tolerance current and/or voltage operating condition of an electric vehicle charging stall 144 that exceeds or falls below a limit setting. Upon encountering and confirming that any such operating condition of an electric vehicle charging stall 144 exists, the control module 222 issues a command to the circuit protection module 220 to open and isolate that electric vehicle charging stall 144 from the common DC bus 102 and reports the status of the circuit protection module 220 to the ARTPMM 160.

The ARTPMM 160 is configured to substantially continuously monitor (i) the current and voltage data received from the control module 222 to determine the state of the common DC bus 102 and (ii) the charging requirements of the electric vehicle charging stalls 144 via the DC to DC converter modules 150 to determine whether the common DC bus 102 in conjunction with the utility grid 114 and/or solar power source 130 are able to satisfy the charging requirements of the electric vehicle charging stalls 144. The ARTPMM 160 is also configured to protect the BESS 120 by enforcing its permitted upper and lower states of charge and its maximum charge and discharge rates and substantially continuously monitors the state of the BESS 120.

During operation, if the common DC bus 102 in conjunction with the utility grid 114 and/or solar power source 130 are unable to satisfy the charging requirements of the electric vehicle charging stalls 144 and the BESS 120 has a state of charge above its permitted lower charge limit, the ARTPMM 160 signals the bi-directional DC to DC converter 122 and the BESS 120 causing the BESS to discharge DC power to the common DC bus 102 to make up for the charging power deficit. The BESS 120 is allowed to discharge DC power to the common DC bus 102 until the charge level of the BESS 120 reaches its permitted lower charge limit or until the power on the common DC bus 102 is sufficient to satisfy the charging requirements of the electric vehicle charging stalls 144. If the common DC bus 102 still requires additional DC power to satisfy the charging requirements of the electric vehicle charging stalls 144 or if the BESS 120 has a state of charge at or below its permitted lower charge limit, the ARTPMM 160 signals the DC to DC converter modules 150 to reduce/curtail the DC power available to the electric vehicle charging stalls 144. During DC power discharge, the ARTPMM 160 monitors the discharge rate of the BESS 120 to ensure the discharge rate of the BESS 120 does not exceed its maximum discharge rate.

If the charge limit of the BESS 120 is below its permitted upper state of charge and available DC power is on the common DC bus 102, the ARTPMM 160 signals the bi-directional DC to DC converter 122 and the BESS 120 allowing the BESS to draw DC power from the common DC bus 102 until the state of charge of the BESS 120 reaches its permitted upper charge limit or until excess DC power is no longer available on the common DC bus 102. During charging, the ARTPMM 160 monitors the charge rate of the BESS 120 to ensure the charge rate of the BESS 120 does not exceed its maximum charge rate.

The ARTPMM 160 is also configured to control the solar power source 130 and the DC to DC converter 132 to allow excess power from the solar power source 130 to be exported to the utility grid 114 via the common DC bus 102.

If regenerative power capture to the third rail of the public transit subway service 106 is permitted as a result of subway train braking, the captured regenerative power can be used to recharge the BESS 120 if its state of charge is below its permitted upper charge limit.

In the embodiment of FIG. 1, a single PCM 142 is employed and is connected between the common DC bus 120 and the electric vehicle charging bay 140. Those of skill in the art will appreciate that alternatives are available. Rather than a single PCM, multiple PCMs 142 may be employed. For example, each electric vehicle charging stall 144 may have a dedicated PCM 142 interconnecting it to the common DC bus 102 or subsets of electric vehicle charging stalls 144 may be serviced by dedicated PCMs 142.

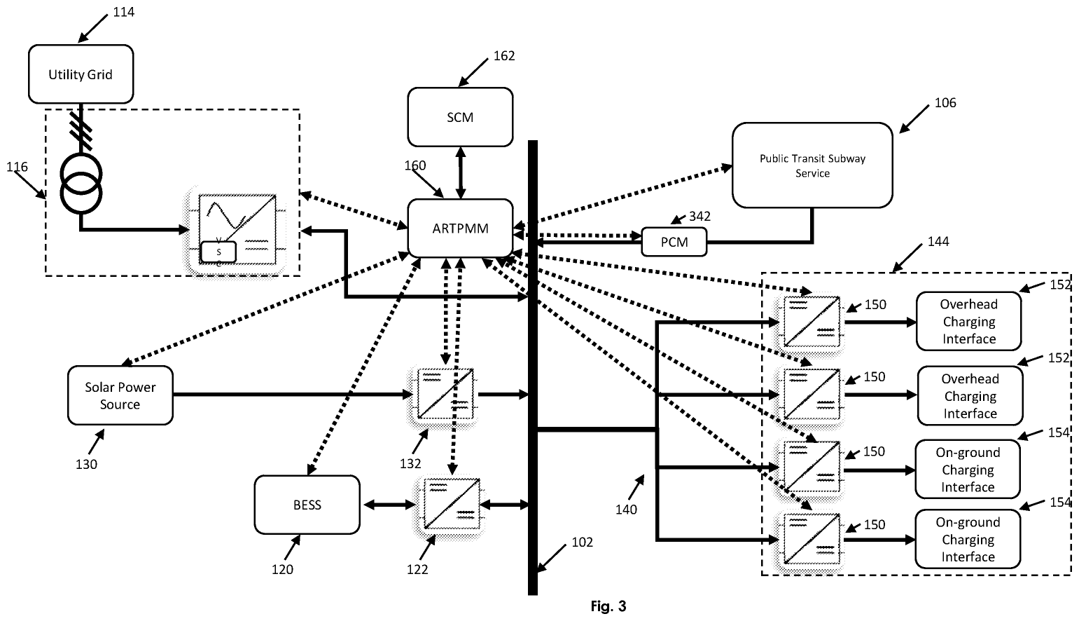

In the embodiment of FIG. 1, the PCM 142 is shown connected between the common DC bus 102 and the electric vehicle charging bay 140. Those of skill in the art will appreciate that alternatives are available. If desired as shown in FIG. 3, the PCM 342 may be connected between the common DC bus 102 and the third rail of the public transit subway service 106.

In the above embodiments, the third rail of the public transit subway service 106 is employed as the primary source or base supply of DC power for the electric vehicle charging depot 100. In situations where the public transit subway service is small, the utility grid 114 or other source(s) of DC power may be used as the primary source or base supply of DC power and the third rail of the public transit subway service 106 may be used to supplement DC power and act as a DC compensator to ensure the DC power provided on the common DC bus 102 is at a sufficient level to meet electric vehicle charging needs.

Although embodiments have been described, those of skill in the art will appreciate that variations and modifications may be made without departing from the scope of the appended claims.

What is claimed is:

1. An electric vehicle charging depot comprising:
a direct current (DC) bus configured to receive DC power from one or more power sources, the one or more power sources at least including a public transit light rail and/or subway power source;
at least one electric vehicle charging stall connected to the DC bus and configured to charge an electric vehicle load; and
at least one control module configured to monitor and control power flow from the DC bus to the at least one electric vehicle charging stall.

2. The electric vehicle charging depot of claim 1, comprising a plurality of electric vehicle charging stalls, the at least one control module configured to monitor and control power flow from the DC bus to each electric vehicle charging stall.

3. The electric vehicle charging depot of claim 2, wherein the one or more power sources further comprises an energy storage system.

4. The electric vehicle charging depot of claim 3, wherein the at least one control module is configured to monitor and control power flow from the energy storage system to the DC bus and/or power flow from the DC bus to the energy storage system.

5. The electric vehicle charging depot of claim 4, wherein the at least one control module is configured to monitor the state of charge of the energy storage system and to control power flow from the energy storage system and power flow to the energy storage system based on the state of charge of the energy storage system.

6. The electric vehicle charging depot of claim 5, wherein the at least one control module is configured to enable power flow from the energy storage system to the DC bus when the DC power on the DC bus is insufficient to meet electrical vehicle charging loads and the state of charge of the energy storage system is above a lower charge limit, and wherein the at least one control module is configured to enable power flow from the DC bus to the energy storage system when the DC power on the DC bus exceeds electric vehicle charging loads and the state of charge of the energy storage system is below an upper charge limit.

7. The electric vehicle charging depot of claim 6, wherein the at least one control module is configured to monitor the charge and discharge rates of the energy storage system.

8. The electric vehicle charging depot of claim 2, wherein the one or more power sources further comprises at least one renewable energy source.

9. The electric vehicle charging depot of claim 8, wherein the at least one renewable energy source comprises at least one solar power and/or wind power source.

10. The electric vehicle charging depot of claim 8, wherein the at least one control module is configured to monitor and control power flow from the at least one renewable energy source to the DC bus.

11. The electric vehicle charging depot of claim 10, wherein the at least one control module is configured to communicate with at least one DC to DC converter connecting the at least one renewable energy source to the DC bus.

12. The electric vehicle charging depot of claim 1, wherein the at least one control module is configured to isolate the at least one electric vehicle charging stall from the DC bus in the event of an unsafe operating condition.

13. The electric vehicle charging depot of claim 12, wherein the at least one control module is configured to isolate the at least one electric vehicle charging stall from the DC bus in the event of one or more of (i) current flow in an improper direction, (ii) an out of tolerance current condition, (iii) an out of tolerance voltage condition, and (iv) a ground fault condition.

14. The electric vehicle charging depot of claim 2, wherein each electric vehicle charging stall comprises a DC to DC converter module and an electric vehicle charging interface.

15. The electric vehicle charging depot of claim 14, wherein the electric vehicle charging interface of at least one of the electric vehicle charging stalls is configured to engage an electric bus pantograph.

16. The electric vehicle charging depot of claim 14, wherein each electric vehicle charging stall is connected to the DC bus via protection control, and wherein the protection control is responsive to the at least one control module to isolate the electric vehicle charging stall from the DC bus in the event of an unsafe operating condition.

17. The electric vehicle charging depot of claim 16, wherein the protection control is configured to isolate the electric vehicle charging stall from the DC bus in the event of one or more of (i) current flow in an improper direction, (ii) an out of tolerance current condition, (iii) an out of tolerance voltage condition, and (iv) a ground fault condition.

18. The electric vehicle charging depot of claim 14, wherein each DC to DC converter module comprises a DC to AC converter, a high frequency step down transformer, and an AC to DC converter connected in series.

19. A protection control module for interconnection between at least one electric vehicle charging stall and a direct current (DC) power bus, comprising:
a current monitor configured to measure current flow from the DC power bus to the electric vehicle charging stall;
at least one voltage monitor configured to measure voltage on the DC power bus;
a power flow monitor configured to measure power flow direction between the DC power bus and the electric vehicle charging stall; and
protection control circuity to isolate the DC power bus and the electric vehicle charging stall in the event of an unsafe electric vehicle charging operation.

20. The protection control module of claim 19, wherein the protection control circuitry is configured to isolate the at least one electric vehicle charging stall from the DC bus in the event of one or more of (i) current flow in an improper direction, (ii) an out of tolerance current condition, (iii) an out of tolerance voltage condition, and (iv) a ground fault condition.

21. The protection control module of claim 19, further comprising a power conditioning module configured to filter and stabilize voltage.
